(19) United States
(12) Patent Application Publication
(10) Pub. No.: US 2003/0219623 A1
(43) Pub. Date: Nov. 27, 2003

(54) Solder joints with low consumption rate of nickel layer

(76) Inventors: Cheng Heng Kao, Tao-Yuan Hsien (TW); Cheng En Ho, Hsu Lin City (TW); L. C. Shiau, Nan Tou Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/414,043

(22) Filed: Apr. 16, 2003

(30) Foreign Application Priority Data
May 21, 2002 (TW) 91117796

(51) Int. Cl. B32B 15/01

(52) U.S. Cl. 428/675

(57) ABSTRACT

A solder joint structure comprises a solder of a Sn alloy especially having Cu element contained therein, a contact region having a Ni layer been composed therein. In which, by means of controlling the Cu concentration to select an interface reaction product for reducing the consumption rate of the Ni layer of the contact region so as to provide an durable strength therefore.

### BACKGROUND OF THE INVENTION

1. Field of the Invention

The present invention relates to a structure of a solder joint of an electronic device, more particularity, to a structure of a solder joint that the consumption rate of a Ni layer of a contact region is reduced by controlling the concentration of copper element in the solder joint such that a more protective reaction product forms at the interface between the solder joint and the Ni layer of the contact region.

2. Description of the Related Art

In the electronic age, electronic products are wildly used in the daily life of everyone. The central part of any electronic product is the integrated circuit chip. The chip has to be connected electrically to a substrate by a packaging process, and then the substrate has to be connected electrically to a motherboard. Solder joints of various types are used to connect the chip to the substrate, and to connect the substrate to the motherboard. The solder joints take responsibility of electrical connecting as well as physical supporting, therefore a solder joint should has good physical strength to prevent the electronic device form damages. In fact, as many as 80% of the failures in electronic devices are due to failures of poor solder joints, therefore improving the quality of solder joints is an important problem to be solved.

FIG. 1 is a cross-sectional view of a conventional solder joint showing a solder joint 120 and a contact region 110 seated on an electronic device 100. The contacting region 110 can be called a “soldering pad” or an “under bump metallurgy” according to the field of application. The contacting region can be composed of a Cu layer 112 over the electronic device 100, a Ni layer 114 over the Cu layer 112, and a Au layer 116 over the Ni layer 114. The solder 120 is composed of an alloy of Sn, such as Pb—Sn or Ag—Sn.

At the beginning of soldering, the gold in the Au layer 116 will enter the solder 120 rapidly to form the compound (Au, Ni)Sn₄. After the Au layer 116 is consumed completely, the Ni layer 114 then comes into contact with the solder 120 and starts to react with Sn in solder 120 to form the compound Ni₃Sn₄. When the Ni layer is also fully consumed, the Cu layer 112 will rapidly reacted with the solder 120. Since the reacting rate of the Cu layer 112 with the solder is at least 10 times faster than the reacting rate of the Ni layer 114 with the solder, the Cu layer 112 will be consumed rapidly after the Ni layer 114 is gone. In that case, the strength of the solder joint will be very low, making the electronic device fails easily if subject to external force.

### SUMMARY OF THE INVENTION

Therefore, an object of the present invention is to provide a solder joint having a Cu element contained therein, and by means of controlling the concentration of Cu in the solder a more protective reaction product at the interface between the solder joint and the Ni layer of the contact region is selected to from so as to reduce the consumption rate of the Ni layer.

Further, there are three more alternative ways to provide an effective Cu concentration in the solder other than aforesaid typical way to have Cu in the solder joint directly. The first way is to coat an extra Cu layer on the contact region which is opposite to the contact region with the Ni layer. The second way is to dispose an extra Cu layer between the solder joint and the Ni in the contact region. The third way is to alloy Cu into the Ni layer of the contact region directly.

### BRIEF DESCRIPTION OF THE DRAWINGS

The above and further objects, features and advantages of the invention will become clear from the following more detailed description when read with reference to the accompanying drawings in which:

FIG. 1 is a cross-sectional view of a conventional solder joint;

FIG. 2 is a cross-sectional view of a solder joint according to the present invention;

FIG. 2A is a metallographic photograph of a Pb—Sn alloy solder joint without adding Cu after 2 min. of soldering of the present invention;

FIGS. 2B, 2C and 2D are metallographic photographs of Pb—Sn alloy solder joints with Cu added in different concentrations after 2 min. of soldering of the present invention;

FIG. 3A is a metallographic photograph of a Pb—Sn alloy solder joint without adding Cu after reacting at 225° C. for 4 hours of the present invention;

FIG. 3B is a metallographic photograph of a solder joint with Cu added after reacting at 225° C. for 4 hours of the present invention;

FIG. 4A is a metallographic photograph of a Pb—Sn alloy solder joint without adding Cu after aging at 160° C. for 2000 hours of the present invention;

FIG. 4B is a metallographic photograph of a solder joint with Cu added after aging at 160° C. for 2000 hours of the present invention;

FIG. 5 is a diagram showing the growth rate of different reaction products during heat treatment of the present invention;

FIG. 6A is a metallographic photograph of a solder joint using the Sn-3.5Ag (wt %) solder, taken after 2 min. of soldering of the present invention;

FIG. 6B is a metallographic photograph of a solder joint using the Sn-4Ag-0.5Cu (wt %) solder, taken after 2 min. of soldering of the present invention;

FIG. 6C is a metallographic photograph of a solder joint using the Sn-4Ag-0.75Cu (wt %) solder, taken after 2 min. of soldering of the present invention;

FIG. 7A is a metallographic photograph of a solder joint using the Sn-3.5Ag (wt %) solder after aging at 180° C. for 300 hours of the present invention;

FIG. 7B is a metallographic photograph of a solder joint using the Sn-3.5Ag-0.5Cu (wt %) solder after aging at 180° C. for 300 hours of the present invention;

FIG. 7C is a metallographic photograph of a solder joint using the Sn-3.5Ag-0.75Cu (wt %) solder after aging at 180° C. for 300 hours of the present invention;

FIG. 8 is a cross-sectional view showing an alternative way of incorporating Cu by coating a Cu layer on the contact region which is opposite to the contact region with the Ni layer according to an embodiment of the present invention; and

FIG. 9 is a cross-sectional view of another embodiment showing another embodiment of incorporating Cu by coating an extra Cu layer over the Ni layer of the present invention.

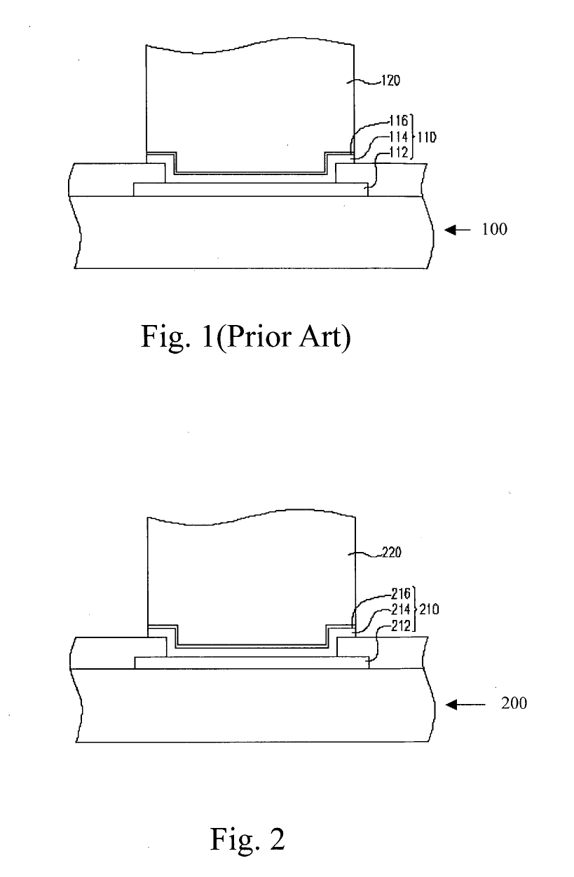

### DETAILED DESCRIPTION OF THE PREFERRED EMBODIMENTS

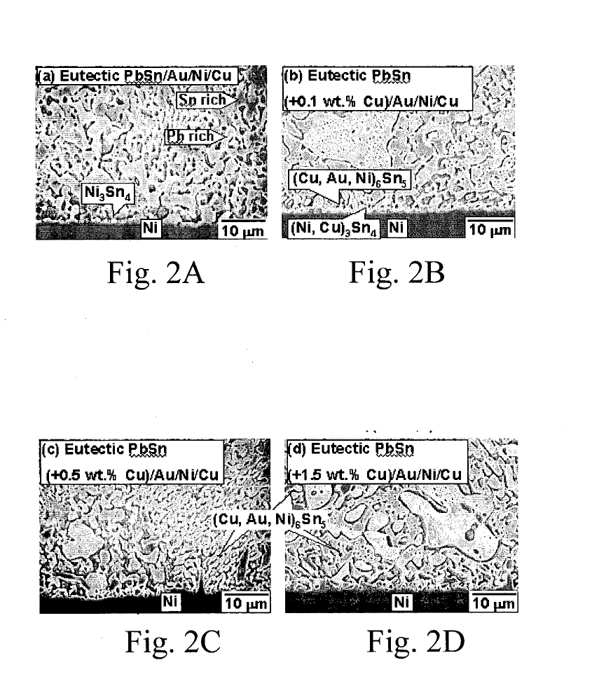

Referring to FIG. 2, a typical embodiment according to the present invention comprises a Cu doped solder 220, which the solder 220 can be an alloy of Pb—Cu—Sn or an alloy of Ag—Cu—Sn, and a contact region 210 seated on a electronic component 200 such as a chip, a substrate or a motherboard. The contact region 210 is composed of a Cu layer 212, a Ni layer 214 and an Au layer 216, in which the Ni layer 214 is deposited over the Cu layer 212 by means of electroplating, electroless plating, sputtering or evaporation. The thickness of Ni can be from 50 nm to 15 μm. The Au layer 216 is deposited over the Ni layer 214 by electroplating or electroless plating. The solder 220 is formed onto the Au layer 216 by means of screen-printing followed by reflowing, or by solder ball plating followed by reflowing.

Referring to FIGS. 2A, 2B, 2C and 2D, there are metallographic photographs after 2 min. of soldering. The Cu concentration in these solder joints is form 0.0 wt % to 1.5 wt %. FIG. 2A shows a diagram of a Pb—Sn alloy solder joint; FIG. 2B shows a diagram of a Pb—Sn alloy solder joint with 0.1 (wt %) Cu added; FIG. 2C has a Cu concentration of 0.5 (wt %); FIG. 2D has a Cu concentration of 1.5 (wt %). Before soldering, the thickness of a Au layer of the contact region is 0.8-1.2 μm, and the thickness of a Ni layer and Cu layer is 6-8 μm and 7 μm, respectively. As shown in FIG. 2A, the reaction product at the interface is Ni₃Sn₄. As shown in FIGS. 2C and 2D, when the Cu concentration becomes higher, the reaction product at the interface becomes a simple and continuous (Cu, Au, Ni)₆Sn₅.

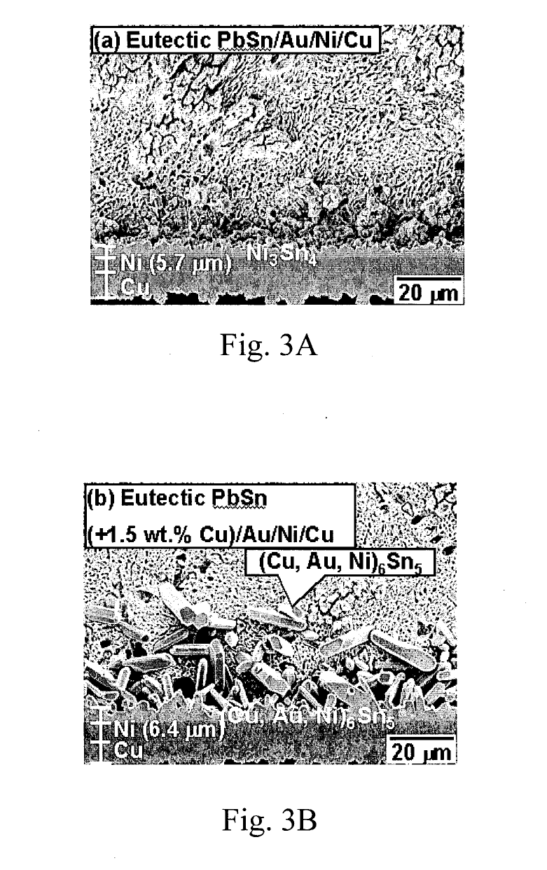

Referring to FIGS. 3A and 3B, the effect of Cu concentration on the reaction product is illustrated more clearly. The solder joints in FIGS. 3A and 3B has been reacted at 225° C. for 4 hours. There is no Cu added in FIG. 3A, and the reaction product is Ni₃Sn₄. In FIG. 3B, 1.5 wt % Cu has been added, and the reaction product is (Cu, Au, Ni)₆Sn₅. Comparing FIGS. 3B and 3A, it is clear that adding Cu into solder joints can reduce the consumption rate of the Ni layer during soldering.

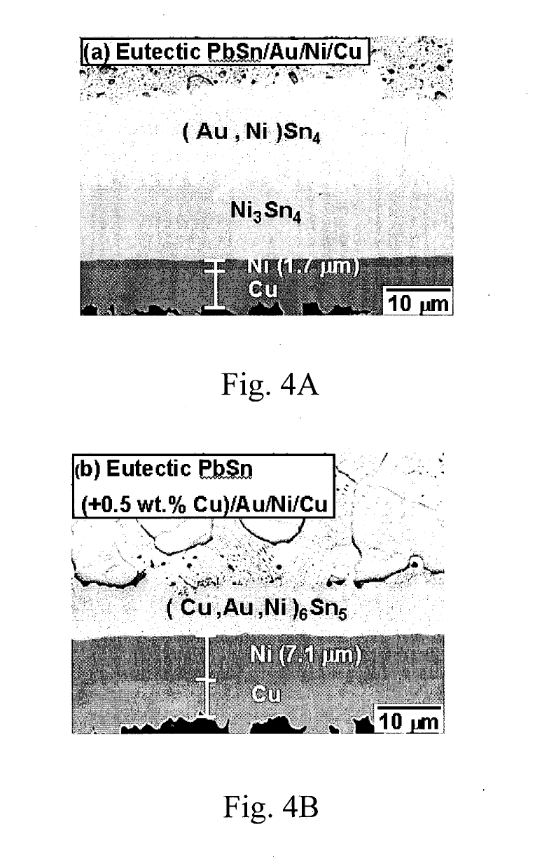

Refer to FIG. 4A FIG. 4B, which shows the result of thermal aging at 160° C. for 2000 hours for solder joints with and without Cu added, respectively. FIG. 4A shows a layer of Ni₃Sn₄ with a thickness of 13 μm, and a layer of (Au, Ni)Sn₄ with a thickness of 14 μm. The remaining Ni layer thickness is only 1.7 μm. While FIG. 4B is a metallographic diagram of a solder joint with 0.5 wt % Cu added. Here, the interface product is a layer of (Cu, Au, Ni)₆Sn₅, and there are no (Au, Ni)Sn₄. More importantly, the thickness of the remaining Ni layer is 7.1 μm. This result shows that the consumption rate of Ni layer in FIG. 4B has been greatly reduced in comparison to that shown in FIG. 4A. This is because of the fact that the Ni concentration in Ni₃Sn₄ is much higher than that of (Cu, Au, Ni)₆Sn₅ compound.

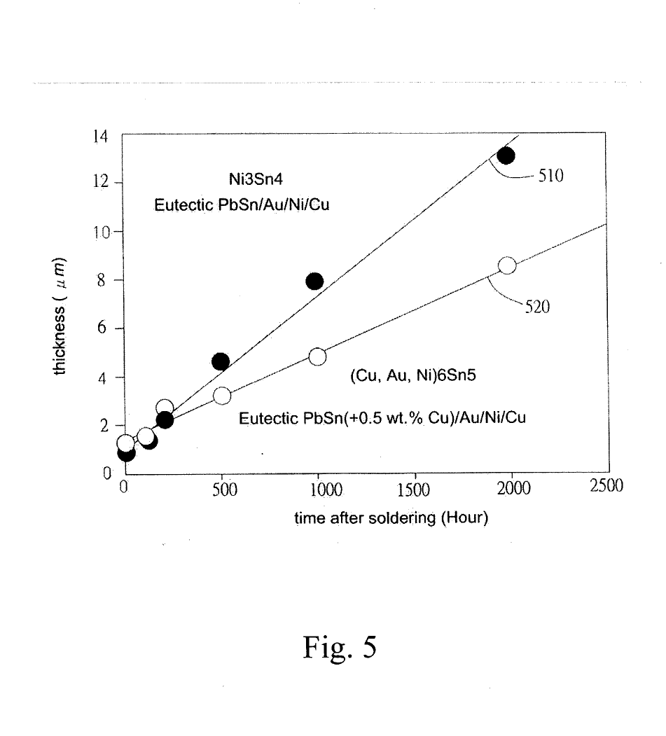

Refer to FIG. 5, which is a diagram showing the different growing rate of Ni₃Sn₄ in comparison to(Cu, Au, Ni)₅Sn₆ at 160° C. In FIG. 5, line 510 shows the thickness (μm, vertical coordinate) of the Ni₃Sn₄, and line 520 shows the thickness of same state of a (Cu, Au, Ni)₆ Sn₅ compound. It is clear that the growth rate of Ni₃Sn₄ is much higher than the growth rate of (Cu, Au, Ni)₆ Sn₅.

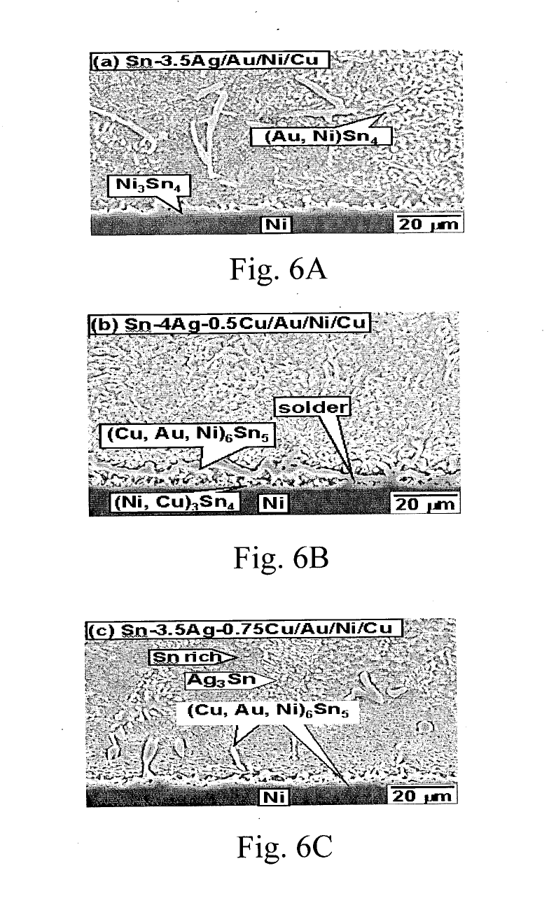

Refer to FIGS. 6A, 6B and 6C, which show the metallographic diagrams of a Sn—Ag3.5 (wt %) solder joint, a Sn-4Ag-0.5Cu (wt %) solderjoint, and a Sn-3.5Ag-0.75Cu solder joint, respectively. These three pictures are solder joint after 2 min. reflowing. The reaction product at the interface in FIG. 6A is a simple and continuous Ni₃Sn₄. The reaction product at the interface in FIG. 6B is a mixture of (Ni, CU)₃Sn₄ and (Cu, Au, Ni)₆Sn₅. The reaction product at the interface in FIG. 6C is a simple and continuous (Cu, Au, Ni)₆Sn₅ layer. These results shows that behavior for the Sn—Ag solders is very similar to the behavior for the Pb—Sn solders shown in FIGS. 2A, 2B and 2C. Furthermore, this research has been extended to various Ag concentration, including 1, 3 and 4 wt %, and the results did not show that the Ag concentration has no obvious effect on the interfacial reaction. Therefore, Cu concentration is the major factor for selecting the interfacial reaction product for reducing the consumption rate of the Ni layer.

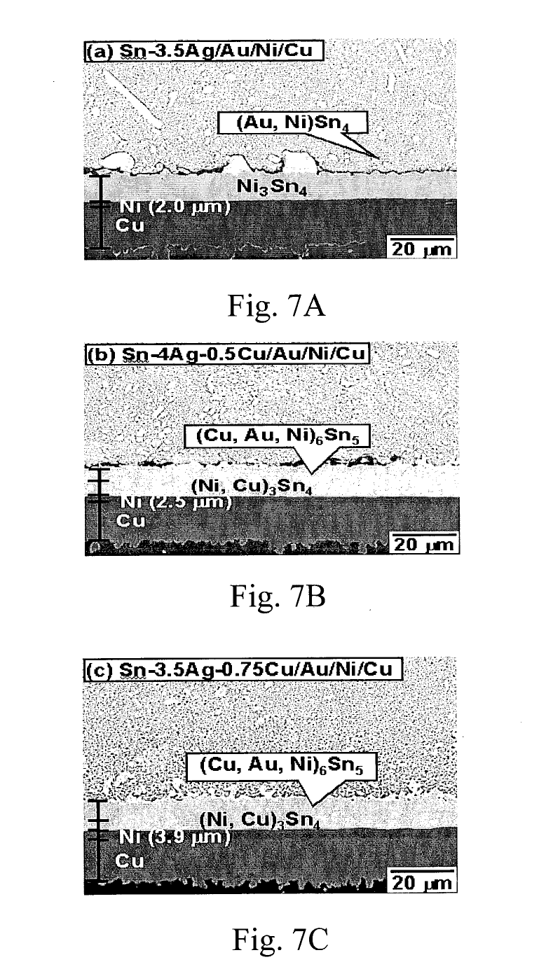

Now please refer to FIGS. 7A, 7B and 7C, which show the metallographic diagrams for a Sn-3.5 Ag (wt %) solder joint, a Sn-4 Ag-0.5 Cu (wt %) solder joint, and a Sn-3.5 Ag-0.75 Cu (wt %) solder joint, respectively. These three solder joint had been aged at 180° C. for 300 hours. In FIG. 7A, the reaction product is a Ni₃Sn₄ and (Au, Ni)Sn₄; in FIG. 7B, the reaction product is (Ni, Cu)₃Sn₄ and (Cu, Au, Ni)₆ Sn₅; in FIG. 7C, the reaction product is the same as in FIG. 7B, but the thickness of the remaining Ni layer (3.9 μm) is much thickness than the remaining Ni layer in FIG. 7B (2.6 μm). This means that increasing the Cu concentration in a solder joint can also reduce the consumption rate of the Ni layer for the Sn—Ag and Sn—Ag—Cu solders.

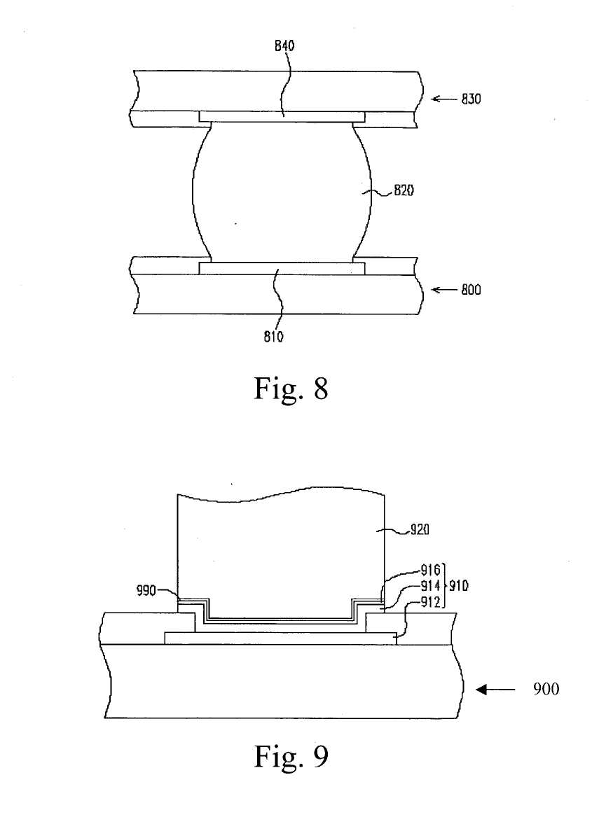

FIG. 8 is a cross-sectional view showing the alternative way of incorporating Cu into solder to produce the desirable compound at the interface. In FIG. 8, the solder 820 is soldered between a first contact region 810 seated on a substrate or a motherboard 800 and a second contact region 810 is similar to the structure of the contact region in FIG. 2, and the contact region 840 can have a layer of Cu exposed to the solder 820. The Cu in contact region 840 can diffuse into the solder 820 and provide the necessary Cu atoms to induce the formation of the desirable compound.

FIG. 9 is a cross-sectional view showing another alternative way of incorporating Cu into solder. In FIG. 9, the contact region 910 has four layers, a Cu layer 990, an Au layer 916, a Ni layer 914, and a Cu layer 912. During soldering, the first Cu layer 990 will dissolved into the solder and provide the necessary Cu atoms to induce the formation of the desirable compound. The Cu layer 990 can also locate between the Au layer 916 and the Ni layer 914.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the present invention.

1. A solder joint characteristically containing a copper element fits to a contact region with at least a nickel layer therein in which by means of controlling the copper concentration to select an reaction product between said solder joint and said contact region to protect said nickel layer for reducing the consumption rate of said nickel layer so as to provide an durable strength therefore.

2. The solder joint according to claim 1, wherein said solder joint containing Cu element is mainly a Sn alloy.

3. The solder joint according to claim 2, wherein said Sn alloy contains Pb component.

4. The solder joint according to claim 2, wherein said Sn alloy contains Ag component.

5. The solder joint according to claim 1, wherein said reaction product is preferably a layer of (Cu, Ni)₆Sn₅ compound produced in a continuous form.

6. The solder joint according to claim 1, wherein said copper concentration of a solder joint is ranged in 0.05˜5 wt %.

7. The solder joint according to claim 6, wherein said copper concentration in a Pb—Sn alloy is preferably at least 0.5 wt % for selecting a (Cu, Ni)₆Sn₅ interface product between said solder joint and said contact region.

8. The solder joint according to claim 6, wherein said copper concentration in an Ag—Sn alloy is preferably at least 0.5 wt %.

9. The solder joint according to claim 1, wherein said contact region is composed of a Ni layer laid on a Cu layer and covered by a Au layer.

10. The solder joint according to claim 9, wherein said Ni layer of said contact region has a thickness of 50 nm to 15 μm.

11. The solder joint according to claim 9, wherein said Cu layer has a thickness 1˜20 μm before soldering.

12. The solder joint according to claim 9, wherein said Au layer has a thickness of 0.01˜1.2 μm before soldering.

13. The solder joint according to claim 10, wherein said Ni layer of said contact region has a P element contained therein.

14. The solder joint according to claim 10, wherein said Ni layer of said contact point has a Co element contained therein.

15. The Solder joint according to claim 10, wherein said Ni layer of said contact point has a V element contained therein.

16. The Solder joint according to claim 1, wherein said solder joint using an alternative way for reducing consumption rate of said Ni layer is to use a non Cu-bearing solder soldering between two opposite contact regions, in which one contact region having a Cu layer exposed to solder therin.

17. The Solder joint according to claim 1, wherein said solder joint using an alternative way for reducing consumption rate of said Ni layer is to coat a layer of Cu on a surface of said solder joint without Cu component.

18. The Solder joint according to claim 1, wherein said solder joint using an alternative way for reducing consumption rate of said Ni layer is to alloy Cu element directly to said Ni layer therein.
